(19) United States
(12) Patent Application Publication
(10) Pub. No.: US 2016/0186725 A1
(43) Pub. Date: Jun. 30, 2016

(54) THERMAL WIND TURBINES

(71) Applicant: Nestor Dofredo, Seattle, WA (US)

(72) Inventor: Nestor Dofredo, Seattle, WA (US)

(21) Appl. No.: 15/061,675

(22) Filed: Mar. 4, 2016

(51) Int. Cl. F03D 9/00; F03D 1/04; F03D 1/02

(52) U.S. Cl. CPC F03D 9/007; F03D 1/025; F03D 1/04

(57) ABSTRACT

Thermal wind turbines capable of capturing energy from both blowing wind, and rising air heated by sunlight or another source of heat. The thermal wind turbine is equipped with two turbines, one optimized for receiving rising air, and the other optimized for receiving lateral winds. These turbines are installed into a housing designed to funnel air effectively through both turbines. The housings equipped with adjustable louvers for optimizing flow through the turbine system as wind and heat conditions vary.

### BACKGROUND

The present disclosure relates generally to clean sustainable energy generation. In particular, turbines for capture of both wind and thermal energy for conversion into electricity are described.

Green sustainable energy generation is of critical importance as our world accelerates transition from fossil fuels to clean energy as part of the ongoing effort to stem worsening climate change, and reliance on foreign sources for importing energy supplies. Part of the portfolio of possible green energy sources in wind power. Utilities across the country have invested substantial sums in establishing large farms for capturing and generating power from the wind. However, known wind turbines are not entirely satisfactory for the range of applications in which they are employed. For example, existing wind turbines rely almost exclusively upon blowing wind for energy generation, and are ineffective when the wind comes to a standstill. For this reason, energy companies cannot rely exclusively on wind power, but must resort to types of base load power generation in situations where the wind may not be blowing, yet there is abundant sunshine.

Conversely, solar generating systems do not rely upon wind, but are ineffective at night, and of reduced effectiveness during dark or overcast days. A combination of wind and solar power can cover both contingencies, however, such an implementation increases cost as two wholly different modes of energy generation must be built.

Thus, there exists a need for wind turbines that improve upon and advance the design of known wind turbines. Examples of new and useful thermal wind turbines relevant to the needs existing in the field are discussed below.

### SUMMARY

The present disclosure is directed to a thermal wind turbine that is capable of capturing energy from both blowing wind, and rising air heated by sunlight or another source of heat. The thermal wind turbine is equipped two turbines, one optimized for receiving rising air, and the other optimized for receiving lateral winds. These turbines are installed into a housing designed to funnel air effectively through both turbines. The housing is equipped with adjustable louvers for optimizing flow through the turbine system as wind and heat conditions vary.

### BRIEF DESCRIPTION OF THE DRAWINGS

FIG. 1 is a side perspective view of an example of a thermal wind turbine, showing the interior structures.

FIG. 2 is a top view of the thermal wind turbine shown in FIG. 1 depicting the profile of the upper turbine blades and associated one-way ratcheting mechanism.

FIG. 3 is a cutaway side view of the thermal wind turbine shown in FIG. 1 depict the relation of the upper and lower turbines.

FIG. 4 an exploded view of the thermal wind turbine shown in FIG. 1.

### DETAILED DESCRIPTION

The disclosed thermal wind turbines will become better understood through review of the following detailed description in conjunction with the figures. The detailed description and figures provide merely examples of the various inventions described herein. Those skillet in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various thermal wind turbines are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

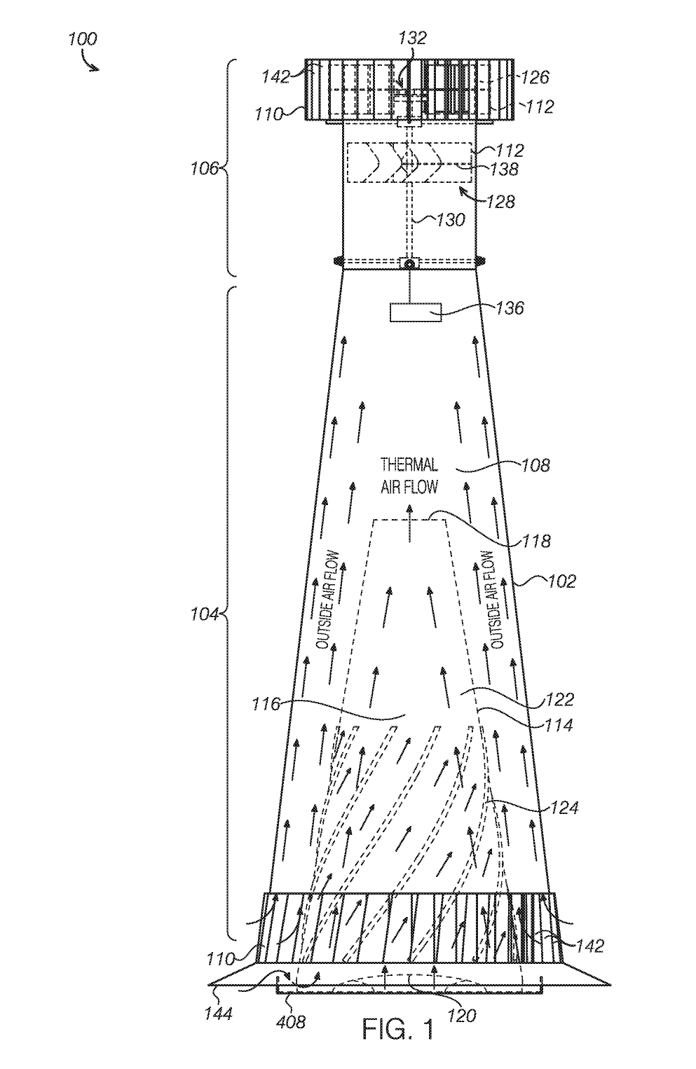

With reference to FIGS. 1-4, an example of a thermal wind turbine, thermal wind turbine 100, will now be described. Thermal wind turbine 100 functions to capture energy both from wind, as well as thermal energy through heated rising air. Thermal wind turbine 100 ideally is designed to keep both wind and heated rising air separate as much as possible until passing through a series of turbines, so as to optimize energy transfer. The reader will appreciate from the figures and description below that thermal wind turbine 100 addresses shortcomings of conventional wind turbines.

For example, by harnessing energy from both moving air and/or heated rising air, thermal wind turbine 100 can generate electricity during times when little wind is blowing, but abundant heated air is present. The converse holds true as well, with thermal wind turbine 100 being able to capture energy from wind alone when there is relatively little heated air, such as during cooler but windy conditions, as might be experienced at night. This ability to generate power from dual energy sources within a single generating facility dramatically reduces costs that would otherwise be incurred by having to build both wired and solar facilities.

Further, by keeping wind and heated air separate until just prior to passing through the turbine stages, thermal wind turbine 100 maximizes efficiency of energy capture, as the rising motion of the heated air joins moving air from wind that has been directed in the same path of travel as the heated air. Thus, the heated air is protected from cooler wind that is moving at a direction perpendicular to naturally rising heated air.

In FIG. 1, thermal wind turbine 100 includes a housing 102, which is further comprised of a lower housing section 104 and an upper housing section 106. The lower and upper housing sections 104, 106 define an internal cavity 108. Lower housing section 104 and upper housing sections both include a plurality of openings 110 disposed so as to allow air to flow from outside lower housing section 104, through internal cavity 108, and escape internal cavity 108 through upper housing section 106. A turbine assembly 112 is contained within upper housing section 106 in internal cavity 108. Turbine assembly 112 is positioned within internal cavity 108 so as to interact with the air flowing through internal cavity 108.

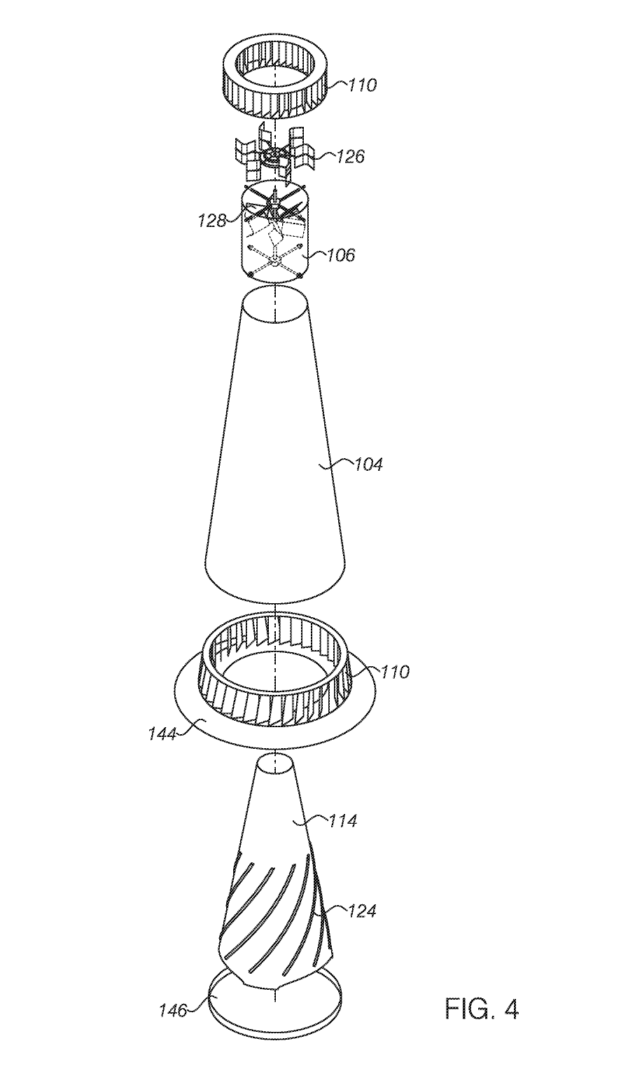

As is demonstrated in FIGS. 1 and 4, lower housing section 104 is substantially frustoconical in shape, with the upper, narrower portion of lower housing section 104 being sued so as to receive upper housing section 106. Lower housing section 104 is open on its upper end to allow air to flow through to upper housing section 106. Upper housing section 106 is substantially cylindrical in shape, and is hollow on each end to receive airflow and exhaust it out the top of housing 102. The conjunction of lower housing section 104 and upper housing section 106 creates continuous internal cavity 108. Lower housing section 104 and upper housing section 106 can be constructed from metal, wood, plastic, composites, a combination of materials, or any other suitable material that is capable of supporting the internal structures while absorbing the load of winds while in use. Furthermore, lower housing section 104 and upper housing section 106 can be manufactured from different materials. Upper housing section 106 attaches and secures to lower housing section 104 by any method that allows for a secure air-tight fit. Alternatively, lower housing section 104 and upper housing section 106 can be manufactured as a single piece housing 102.

Housing 102 is preferably manufactured from a transparent or translucent material so as to allow for transfer of solar energy to heat the ground underneath thermal wind turbine 100, maximizing the amount of heated air fed into thermal wind turbine 100.

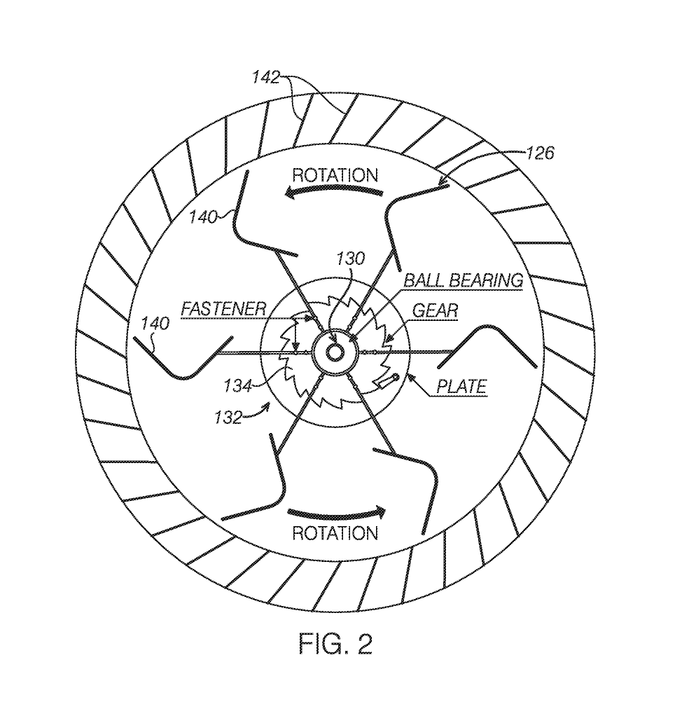

One each of plurality of openings 110 are located on lower housing section 104 and upper housing section 106. FIGS. 1 and 2 show the location of each of plurality of openings 110, with one of the openings 110 located just above the base of lower housing section 104, and the second opening 110 located around the top of upper housing section 106. Each of plurality of openings 110 provides a pathway for air to move into and through internal cavity 108. Air flow through plurality of openings 110 can be controlled by a plurality of louvers 142 arranged radially around each opening 110. Louvers 142 are preferably articulated to allow adjustment of each opening 110 with respect to wind direction, and to divert wind through internal cavity 108 at an optimized direction and speed. Thus, louvers 142, in particular louvers 142 that ring upper housing section 106, are able to utilize outside id in any direction to him the turbine system. Louvers 142 around lower housing section 104 likewise harness wind force from any direction, but direct it to go upward through internal cavity 108. The dimension and number of louvers 142 may vary consistent with wind power and force as needed to maximize efficiency. Louvers 142 may be made from similar materials to housing 102, or differing materials.

Louvers 142 may be controlled by an automatic control mechanism as is known in the art which receives feedback from instrumentation that determines wind speed and direction and adjusts louvers 142 in response. Louvers 142 may further be individually articulated to create specific channels through housing 102 which direct wind across and/or through the turbine system.

To aid in efficient use and direction of both and heated air, thermal wind turbine 100 further includes a frustoconical baffle 114 disposed within internal cavity 108 and substantially in lower housing section 104, below turbine assembly 112. Frustoconical baffle 114 further defines a hollow interior 116, a smaller diameter opening 118 disposed proximate to turbine assembly 112, and that opens to internal cavity 108, and a larger diameter opening 120 positioned so as to receive outside air flow. Thus, frustoconical baffle 114 sits concentrically within lower housing section 104. Due to its position within internal cavity 108, frustoconical baffle 114 has an outer surface 122 that faces internal cavity 108, disposed apart from and opposite to the interior of internal cavity 108.

Upon outer surface 122 are located a plurality of fins 124, positioned so as to direct air flowing between outer surface 122 and lower housing section 104 into turbine assembly 112. A substantial lower portion of frustoconical baffle 114 sits opposite to opening 110 located near the base of lower housing section 104. Louvers 142 on opening 110 direct air onto plurality of fins 124, which in turn guide the moving air up through internal cavity 108. Plurality of fins 124 are depicted as being arranged in an essentially helical or spiral pattern in FIGS. 1 and 4; however, the arrangement of plurality of fins 124 may be modified or adjusted to maximize efficient air flow depending upon the size and configuration of thermal wind turbine 100. Correspondingly, heated air rises into larger diameter opening 120, passes through hollow interior 116, and through smaller diameter opening 118 to join with wind moving up through internal cavity 108 over outer surface 122 before reaching the turbine assembly 112. Frustoconical baffle 114 is manufactured from similar materials as housing 102.

A shield 144 disposed immediately below plurality of openings 110 on lower housing section 104 extends radially away from lower housing section 104. Below shield 144 is a second opening 146 through which heated air may be accepted through larger diameter opening 120 into hollow interior 116, where it travels up through smaller diameter opening 118 so as to mix with cooler air accepted through opening 110 located on lower housing section 104. Shield 144 serves to prevent wind from entering into second opening 146, so that second opening 146 is limited to heated air only.

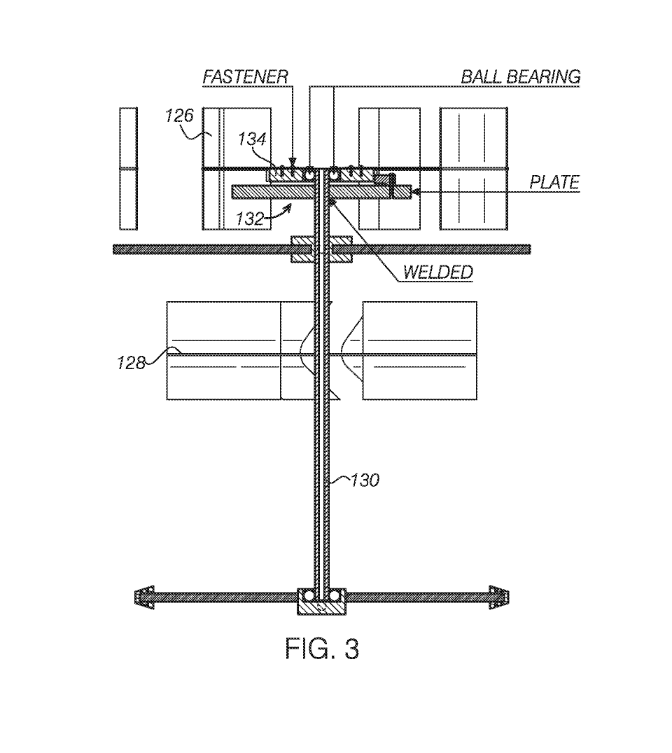

Turning to FIGS. 2 and 3, turbine assembly 112 is comprised of a upper turbine 126 and a lower turbine 128, wherein upper turbine 126 and lower turbine both rotate upon a common central shaft 130. Upper turbine 126 is affixed to common central shaft 130 via a one-way clutch mechanism, such that lower turbine 128 may spin faster than upper turbine 126, while upper turbine 126 cannot spin faster than lower turbine 128. The one-way clutch mechanism is preferably comprised of a gear and pawl assembly, the mechanism and operation of which is well-known in the mechanical arts. As depicted, upper turbine 126 is secured to gear 134, which are mounted atop common central shaft 130 via a bearing that allows common central shaft 130 to rotate independently from the assembly of upper turbine 126 and gear 134. A plate with pawl 132 is affixed to and rotates with common central shaft 130 and lower turbine 128. As can be seen, when lower turbine 128 spins aster than upper turbine 126, the plate with pawl 132 rotates in synchronization with lower turbine 128, while the pawl skips over teeth of gear 134. Conversely, when upper turbine reaches the speed of lower turbine 128, the teeth of gear 134 catches and holds the pawl, thereby imparting rotational force to plate with pawl 132, common central shaft 130 and lower turbine 128 so as to cause the entire turbine assembly 112 to rotate at a single speed.

It will be appreciated by a person skilled in the relevant art that one-way clutch mechanism can be implemented using any known method or mechanism for ensuring that lower turbine 128 spins at the same speed or faster than upper turbine 126 that is now known or later developed.

Common central shaft 130 is mechanically linked to a generator 136 such that rotational energy imparted to common central shaft 130 by either or both turbines is imparted to generator 136. Generator 136 is any device that can be used to generate electricity that is now known or later developed in the art. Alternatively, generator 136 can be implemented as a power take off for harnessing the raw mechanical power from the turbine assembly 112.

Lower turbine 128 is located approximately at the interface between lower housing section 104 and upper housing section 106, and as such receives a substantially vertical air flow. Lower turbine 128 is preferably equipped with a plurality of adjustable-pitch blades 138, which can be automatically controlled. Adjustable-pitch blades 138 enable lower turbine 128 to be optimized for harnessing power for either the wind, heated air, or blend of both received from lower housing section 104. The same controller implemented for controlling plurality of louvers 142 positioned on plurality of openings 110 can coordinate the pitch of adjustable-pitch blades 138 to work in concert with the louvers 142 to optimize airflow through thermal wind turbine 100.

Considering FIGS. 1 and 2, upper turbine 126 is located near the top of upper housing section 106, roughly concentrically within opening 110 on upper housing section 106. At this position upper turbine 126 can capture wind blowing through opening 110 on upper housing section 106 as channeled by plurality of louvers 142. Accordingly, upper turbine 126 is equipped with a plurality of angled blades 140, as seen in profile in FIG. 2. The shape and positioning of plurality of angled blades 140 is such that wind blowing parallel to the plane of upper turbine 126 imparts rotational force.

It will be appreciated by a person skilled in the relevant art that upper turbine 126 receives comparably little energy from vertically rising air coming from lower housing section 104, as understood from the profile of plurality of angled blades 140. Concurrently, the profile of angled blades 140 is designed to minimize cross section with respect to air rising from lower housing section 104, to ensure maximal airflow through lower turbine 128. Energy imparted from rising air is captured by lower turbine 128.

A person skilled in the relevant art will further understand that thermal wind turbine 100 can be manufactured a range of sizes, from small models that could fit on a desktop or in a yard, to large scale models that would be suitable for deployment in a commercial power generation facility. Finally, the design of thermal wind turbine 100 is such that its operation will not be substantially affected by covering the various openings with screens. Equipping the openings, such as plurality of openings 110, with screens will prevent ingestion or ingress of foreign objects that could harm the internal mechanisms of thermal wind turbine 100, and additionally with prevent possible harm to animals such as birds, fowl, and bats. This protection provides an advantage over existing open-air wind turbines that have been known to cause injury to wildlife.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A thermal wind turbine, comprising:
a housing, the housing comprising:
a lower housing section, and
an upper housing section, wherein:
the lower and upper housing sections define an internal cavity, and
the lower housing section and upper housing sections both include a plurality of openings disposed so as to allow air to flow from outside the lower housing section, through the internal cavity, and escape the internal cavity through the upper housing section; and
a turbine assembly contained within the upper housing section internal cavity, wherein:
the turbine assembly is disposed within the internal cavity so as to interact with the air lowing through the internal cavity.

2. The thermal wind turbine of claim 1, wherein the housing is substantially cylindrical in shape.

3. The thermal wind turbine of claim 2, wherein the lower housing section is substantially frustoconical in shape, with the upper housing section disposed upon the smaller diameter opening of the lower housing section.

4. The thermal wind turbine of claim 3, further comprising a second frustoconical housing disposed within the internal cavity substantially in the lower housing section and below the turbine assembly, wherein the second frustoconical housing defines:
a hollow interior,
a smaller diameter opening disposed proximate to the turbine assembly, and that opens to the internal cavity, and
a larger diameter opening positioned so as to receive outside air flow.

5. The thermal wind turbine of claim 4, wherein the second frustoconical housing further comprises:
an outer surface that faces the internal cavity of the lower housing section;
a plurality of fins disposed upon the outer surface and positioned so as to direct air flowing between the outer surface and the lower housing section into the turbine assembly.

6. The thermal wind turbine of claim 1, wherein the turbine assembly is comprised of an upper turbine and a lower turbine.

7. The thermal wind turbine of claim 6, wherein the upper turbine and lower turbine both rotate upon a common central shaft.

8. The thermal wind turbine of claim 7, wherein the upper turbine is affixed to the common central shaft via a one-way clutch mechanism, such that the lower turbine may spin faster than the upper turbine, while the upper turbine cannot spin faster than the lower turbine.

9. The thermal wind turbine of claim 8, wherein the one-way clutch mechanism is comprised of a gear and pawl assembly.

10. The thermal wind turbine of claim 9, wherein the common central shaft is mechanical linked to a generator such that rotational energy imparted to the common central shaft by either or both turbines is imparted to the generator.

11. The thermal wind turbine of claim 6, wherein the lower turbine further comprises a plurality of adjustable-pitch blades.

12. The thermal wind turbine of claim 11, wherein the upper turbine further comprises a plurality of angled blades positioned so as to respond to air flow through the plurality of openings on the upper housing section.

13. The thermal wind turbine of claim 1, wherein the plurality of openings each further comprise a plurality of louvers.

14. The thermal wind turbine of claim 1, further comprising a shield disposed immediately below the plurality of openings on the lower housing section which extends radially away from the lower housing section.

15. A thermal wind turbine, comprising:
a housing further comprising:
a frustoconical lower section, with a plurality of openings disposed near the larger diameter end of the lower section in an annular arrangement,
a cylindrical upper section, with a plurality of openings disposed around at least a portion of the cylindrical upper section in an annular arrangement, and
a hollow interior cavity defined by the lower and upper sections;
a frustoconical baffle disposed centrally inside the hollow interior cavity within the lower section, where the baffle is hollow and open on both the smaller diameter and larger diameter openings;
a lower turbine disposed within the hollow interior cavity within the upper section, and positioned above the smaller diameter opening of the baffle; and
an upper turbine disposed within the hollow interior cavity distal from the smaller diameter opening, which is mechanically linked to the lower turbine via a one way clutch so as to prevent the upper turbine from spinning faster than the lower turbine.

16. The thermal wind turbine of claim 15, wherein the lower turbine and upper turbine are mechanically linked via a central shaft passing through the center hub of both the lower turbine and upper turbine.

17. The thermal wind turbine of claim 16, wherein the lower turbine further comprises a plurality of pitch-adjustable blades.

18. The thermal wind turbine of claim 17, wherein the upper turbine further comprises a plurality of blades disposed to interact with air flow through the plurality of openings disposed on the upper section.

19. The thermal wind turbine of claim 18, wherein the plurality of openings disposed on the lower section and the plurality of openings disposed on the upper section each further comprise a plurality of louvers that can be adjusted to optimize airflow through the thermal wind turbine.

20. The thermal wind turbine of claim 19, wherein the baffle further comprises a plurality of fins located between the outer surface of the baffle and the inner surface of the housing, and arranged so as to optimize airflow through the interior cavity to the lower turbine.
